(19) United States
(12) Patent Application Publication
(10) Pub. No.: US 2012/0282952 A1
(43) Pub. Date: Nov. 8, 2012

(54) METHOD AND DEVICES OF COMMUNICATING LOW DUTY CYCLE PATTERN INFORMATION TO MOBILE STATIONS

(75) Inventors: Anshuman Nigam, Bangalore (IN); Jung-Je Son, Yongin-shi (KR)

(73) Assignee: SAMSUNG ELECTRONICS CO. LTD., Suwon-si, Gyeonggi-do (KR)

(21) Appl. No.: 13/519,034

(22) PCT Filed: Dec. 28, 2010
(86) PCT No.: PCT/KR2010/009395

§ 371 Date: Jun. 25, 2012

(30) Foreign Application Priority Data
Dec. 27, 2010 (IN) 3254/CHE/2009

(51) Int. Cl. H04W 4/00; H04W 68/00

(52) U.S. Cl. 455/458; 455/422.1

(57) ABSTRACT

The present invention provides a method and devices of communicating low duty cycle (LDC) pattern information to mobile stations. In one embodiment, a method of a base station in a telecommunication network for communicating LDC pattern information to one or more mobile stations includes determining validity of one or more LDC patterns used during a LDC mode by at least one femtocell associated with one or more mobile stations. The method further includes communicating LDC pattern information associated with the one or more valid LDC patterns to the one or more mobile stations in real time.

### TECHNICAL FIELD

The present invention relates to the field of telecommunications, and more particularly relates to communicating low duty cycle (LDC) pattern information to mobile stations.

### BACKGROUND ART

A femtocell (also known as home cells) is a lower power base station typically designed for use in a home or small business and intended to enhance network coverage area. Femtocells are likely installed by an end user rather than by a network operator. The end user can move the femtocell geographically from place to place without the operator being able to control relocation of the femtocell. The femtocell may allow one or more mobile stations to connect to a core network through a backhaul link. The coverage area for the femtocell is relatively small as compared to a cell covered by a standard macro cell.

Typically, femtocells can be deployed in a similar frequency allocation as a macrocell associated with a conventional cellular network. Due to this, the placement of femtocells has a critical effect on performance of a wider network as dense deployment of femtocells can inevitably cause interference to mobile station users. For example, a mobile station using a femtocell may experience interference from a nearly located macrocell in down link (DL). On the other hand, in uplink (UL), the femtocell may experience interference from the mobile station using the macrocell. Also, the femtocell may cause interference to the operation of nearby femtocells.

In order to reduce interference caused by a femtocell, and save on operating power of the femtocell, typically the femtocell enters a low duty cycle (LDC) operation mode during absence of any mobile station in its coverage area. A LDC operation mode is a mode in which the femtocell switches to a cycle of available interval (AI) and unavailable interval (UAI). During the AI, the femtocell broadcast a preamble and during the UAI, the femtocell does not transmit the preamble. The respective cycle of AIs and UAIs continues periodically until the femtocell comes out of the LDC operation mode. The femtocell comes out of the low duty cycle mode when the associated mobile stations intimidate its presence to the femtocell. The LDC operation mode helps the femtocell to reduce power consumption and interference to the macrocells and neighboring femtocells.

The mobile station typically has to scan the femtocells in the same manner as it has to scan the macrocells, for the purpose of handover or idle mode reselection. When the femtocell is in a LDC mode, the mobile stations may not find the femtocell for a considerably longer period of time which may impact battery life of the mobile stations due to longer scan operation. To avoid this, typically the pattern in which the femtocell operates in the LDC mode is signaled to the mobile stations so that the mobile stations can efficiently search for a femtocell. Currently, the LDC pattern information is signaled to the mobile stations by a base station through pre-provisioning or during initial network entry.

The LDC patterns for reducing the interference by the femtocell are not static and may change according to changing conditions associated with the femtocell. However, the mobile stations may not be aware of LDC patterns changed subsequent to pre-provisioning or initial network entry operation. Consequently, the mobile stations may search for the femtocell based on the previously signaled LDC pattern information, resulting in inefficient scanning of the femtocell, thereby consuming more power and lowering the battery life.

### DISCLOSURE OF INVENTION

### Solution to Problem

The present invention provides a method and devices of communicating LDC pattern information to mobile stations. In one aspect, a method of a base station in a telecommunication network for communicating low duty cycle (LDC) pattern information to one or more mobile stations includes determining validity of one or more LDC patterns used during a LDC mode by at least one femtocell associated with one or more mobile stations. The method further includes communicating LDC pattern information associated with the one or more valid LDC patterns to the one or more mobile stations in real time.

In another aspect, a base station includes a processor, and memory coupled to the processor and configured to temporarily store instructions capable of performing the method described above.

In yet another aspect, a method of a mobile station for obtaining LDC pattern information from a base station of a telecommunication network includes receiving a message indicating change in LDC pattern information associated with one or more valid LDC patterns from the base station, where the one or more valid LDC patterns are used during a LDC mode by at least one femtocell associated with the mobile station. The method also includes performing a network entry procedure with the base station upon receiving the message indicating the change in the LDC pattern information, and obtaining the LDC pattern information associated with the one or more valid LDC patterns from the base station in real time during the network entry procedure.

In a further aspect, a mobile station includes a processor, and memory coupled to the processor and configured to temporarily store instructions capable of performing the method described above.

Other features of the embodiments will be apparent from the accompanying drawings and from the detailed description that follows.

### BRIEF DESCRIPTION OF DRAWINGS

FIG. 1 is a process flowchart of an exemplary method of communicating low duty cycle (LDC) pattern information to mobile stations, according to one embodiment.

FIG. 2 is a block diagram of a base station showing various components for implementing embodiments of the present subject matter.

FIG. 3 is a block diagram of a mobile station showing various components for implementing embodiments of the present subject matter.

The drawings described herein are for illustration purposes only and are not intended to limit the scope of the present disclosure in any way.

### BEST MODE FOR CARRYING OUT THE INVENTION

The present invention provides a method and devices of communicating low duty cycle (LDC) pattern information to mobile stations. In the following detailed description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention. The following detailed description is, therefore, not to be taken in a limiting sense, and the scope of the present invention is defined only by the appended claims. In the following description, the IEEE802.16m system is taken as an example for the purpose of illustration. This in no way limits the scope of the invention to the IEEE802.16m system.

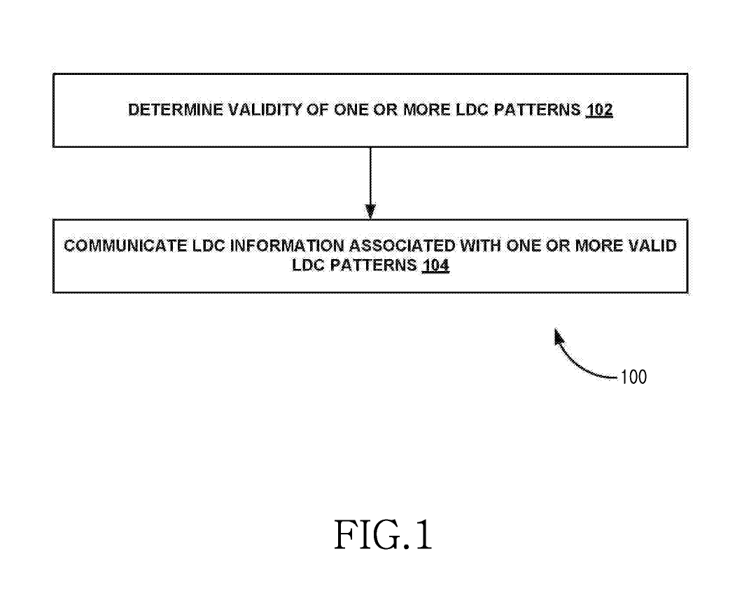

FIG. 1 is process flowchart 100 of an exemplary method of communicating LDC pattern information to mobile stations, according to one embodiment. At step 102, validity of LDC patterns used during a LDC mode by a femtocell associated with mobile stations is determined by a base station (e.g., a femtocell base station, a home base station, macro base station and the like) of a telecommunication network. The LDC patterns are determined as valid when such LDC patterns are currently being used by the femtocells during the LDC mode. In one embodiment, the validity of LDC patterns is determined by the base station upon receiving the LDC patterns from an entity (e.g., a SON server) of the telecommunication network. In an alternate embodiment, the validity of the LDC patterns is determined by the base station upon receiving a request for LDC pattern information from the mobile stations. The base station receives request for LDC pattern information through a new message such as an advanced air interface femto low duty cycle request (AAI_FemtoLDC_REQ) message, or an existing message such as an advanced air interface range request (AAI_RNG_REQ) message.

At step 104, LDC pattern information associated with the valid LDC patterns is communicated to the mobile stations by the base station over a wireless link in real time. Exemplary LDC pattern information communicated to the mobile stations includes a set of LDC parameters, a change count, and/or time associated with applicability of the set of LDC parameters. Exemplary set of LDC parameters includes an available interval, an unavailable interval, and a start offset.

In one embodiment, the LDC pattern information associated with the valid LDC patterns is broadcasted via a broadcast message to mobile stations for a predetermined time interval. The LDC pattern information is included in a new field or a new type length value (TLV) of the broadcast message. The broadcast message may be a new message (e.g., an advanced air interface femto low duty cycle advertisement (AAI_FemtoLDC_ADV), or an existing message (e.g., an advanced air interface self organizing network advertisement (AAI_SON_ADV) message, an advanced air interface neighbor advertisement (AAI_NBR_ADV) message, and a system information message (in system information sub packets or extended system information)). The predetermined time interval may be a time interval associated with multiple of a longest active paging cycle in the telecommunication network. Thus, the mobile stations in idle mode and connected mode can receive the broadcast message.

In an alternate embodiment, a message indicating change in LDC pattern information is generated by the base station and sent to mobile stations (e.g., in idle mode). The change in LDC pattern information may be one bit information or N bit information, where each bit value represents a change count. In one exemplary implementation, the change in LDC pattern information is included in a super frame header or system information sub packets. In another exemplary implementation, the change in LDC pattern information is broadcasted in extended system information. In yet another exemplary implementation, the change in LDC pattern information is broadcasted/multicasted via a paging message.

In a further exemplary implementation, the change in LDC pattern information is broadcasted/multicasted in a LDC change indicator field of an advanced air interface paging advertisement (AAI_PAG_ADV) message. Alternatively, the change in LDC pattern information is indicated in an action code in the advanced air interface paging advertisement (AAI_PAG_ADV) message. In further another exemplary implementation, the change in LDC pattern information is unicasted to the mobile stations in an advanced air interface handover command message during a handover process. The change in LDC pattern information can be included in a new field of the advanced interface handover command message.

A network entry procedure request is sent by each of the mobile stations in response to the message indicating change in the LDC pattern information and thereafter a network entry procedure is performed with the base station. The LDC pattern information associated with the valid LDC pattern information is broadcasted to the mobile stations in real time via a broadcast message for a predetermined time interval. The LDC pattern information is included in a new field or a new type length value (TLV) of the broadcast message.

The broadcast message may be a new message (e.g., an advanced air interface femto low duty cycle advertisement (AAI_FemtoLDC_ADV) message, or an existing message (e.g., an advanced air interface self organizing network advertisement (AAI_SON_ADV) message, an advanced air interface neighbor advertisement (AAI_NBR_ADV) message, and a system information message (in system information sub packets or extended system information)). The predetermined time interval may be a time interval associated with multiple of a longest active paging cycle in the telecommunication network. Thus, the mobile stations in idle mode and connected mode can receive the broadcast message.

The LDC pattern information associated with the valid LDC information is multicasted/unicasted to the mobile stations in real time for a predetermined time interval. Before multicasting or unicasting the LDC pattern information, the base station determines which mobile stations are associated with femtocells in a current geographic area. Accordingly, a registration is performed by the mobile stations with the base station through appropriate setting of handover (HO) process optimization type length value (TLV) and the LDC pattern information is multicasted/unicasted to the determined mobile stations. In exemplary implementation, the LDC pattern information is unicasted to the mobile stations in an new message (e.g., an advanced air interface femto low duty cycle command (AAI_FemtoLDC_CMD)), or an existing message such as an advanced air interface range response (AAI_RNG_RSP) message, an an advanced air interface registration response (AAI_REG_RSP) message, or an AAI_NBR_ADV message.

Accordingly, the broadcast/multicast/unicast message is received by the mobile stations from the base station and the LDC pattern information associated with the valid LDC patterns is decoded. In this manner, the valid LDC pattern information is conveyed to the mobile stations such that the mobile stations can search femtocells at correct timings.

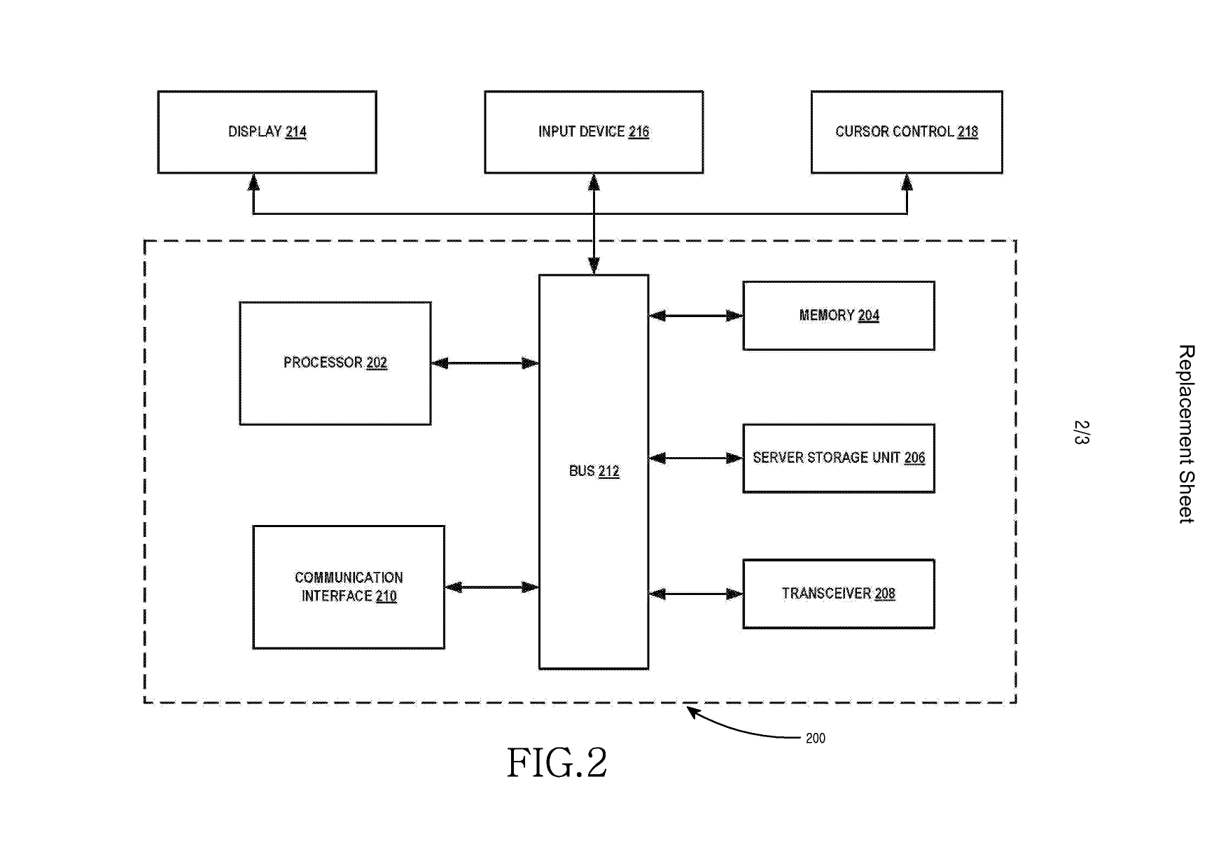

FIG. 2 is a block diagram of a base station 200 showing various components for implementing embodiments of the present subject matter. In FIG. 2, the base station 200 includes a processor 202, memory 204, a server storage unit 206, a transceiver 208, a bus 210, a communication interface 212, a display 214, an input device 216, and a cursor control 218.

The processor 202, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 202 may also include embedded controllers, such as generic or programmable logic devices or arrays, application specific integrated circuits, single-chip computers, smart cards, and the like.

The memory 204 and the server storage unit 206 may be volatile memory and non-volatile memory. The memory 204 includes instructions temporarily stored therein to communicate valid low duty cycle (LDC) pattern information to mobile stations. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 202. For example, a computer program may include machine-readable instructions capable of communicating LDC pattern information to the mobile stations according to the teachings and herein described embodiments of the present subject matter. In one embodiment, the program may be included on a compact disk-read only memory (CD-ROM) and loaded from the CD-ROM to a hard drive in the non-volatile memory. The machine-readable instructions may cause the base station 200 to encode according to the various embodiments of the present subject matter.

The transceiver 208 may be capable of receiving LDC pattern information from an entity in a telecommunication network or receiving a request for valid LDC pattern information from the mobile stations, and communicating the LDC pattern information associated with the valid LDC patterns to the mobile stations. The bus 210 acts as interconnect between various components of the base station 200. The components such as communication interfaces 212, the display 214, the input device 216, and the cursor control 218 are well known to the person skilled in the art and hence the explanation is thereof omitted.

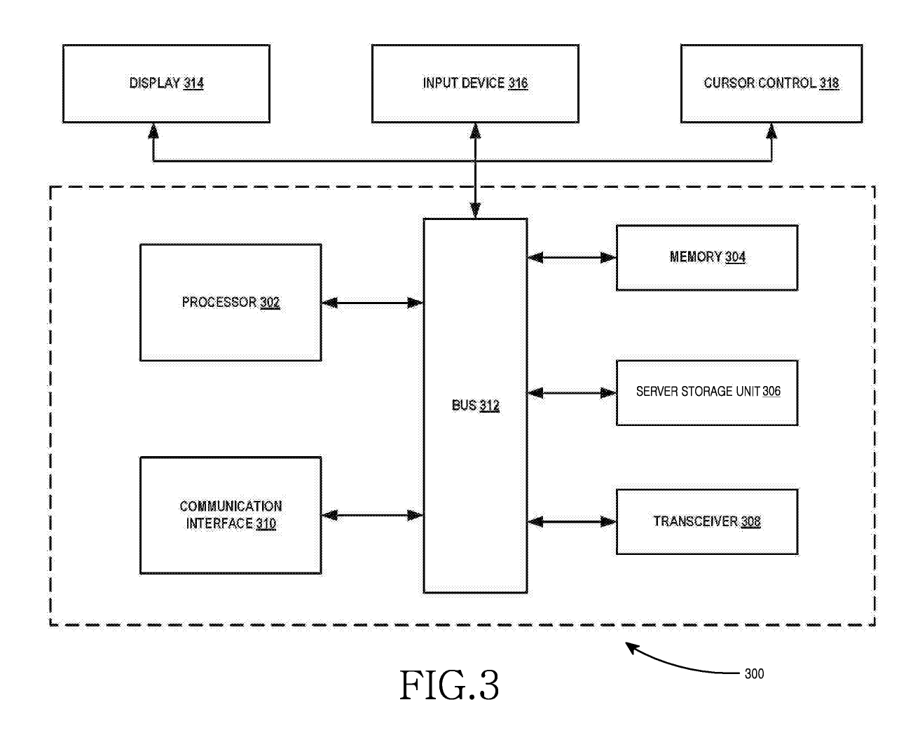

FIG. 3 is a block diagram of a mobile station 300 showing various components for implementing embodiments of the present subject matter. In FIG. 3, the mobile station 300 includes a processor 302, memory 304, a server storage unit 306, a transceiver 308, a bus 310, a communication interface 312, a display 314, an input device 316, and a cursor control 318.

The processor 302, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a graphics processor, a digital signal processor, or any other type of processing circuit. The processor 302 may also include embedded controllers, such as generic or programmable logic devices or arrays, application specific integrated circuits, single-chip computers, smart cards, and the like.

The memory 304 and the server storage unit 306 may be volatile memory and non-volatile memory. The memory 304 includes instructions temporarily stored therein in for receiving LDC pattern information associated with valid LDC patterns from the base station 200 and decoding the same. A variety of computer-readable storage media may be stored in and accessed from the memory elements. Memory elements may include any suitable memory device(s) for storing data and machine-readable instructions, such as read only memory, random access memory, erasable programmable read only memory, electrically erasable programmable read only memory, hard drive, removable media drive for handling compact disks, digital video disks, diskettes, magnetic tape cartridges, memory cards, Memory Sticks™, and the like.

Embodiments of the present subject matter may be implemented in conjunction with modules, including functions, procedures, data structures, and application programs, for performing tasks, or defining abstract data types or low-level hardware contexts. Machine-readable instructions stored on any of the above-mentioned storage media may be executable by the processor 302. For example, a computer program may include machine-readable instructions capable of receiving and decoding the LDC pattern information associated with the valid LDC patterns according to the teachings and herein described embodiments of the present subject matter. In one embodiment, the program may be included on a compact disk-read only memory (CD-ROM) and loaded from the CD-ROM to a hard drive in the non-volatile memory. The machine-readable instructions may cause the mobile station 300 to encode according to the various embodiments of the present subject matter.

The transceiver 308 may be capable of sending a request for valid LDC pattern information and a network entry procedure, and receiving change in LDC pattern information and/or LDC pattern information associated with the valid LDC patterns from the base station 200. The bus 310 acts as interconnect between various components of the mobile station 300. The components such as communication interfaces 312, the display 314, the input device 316, and the cursor control 318 are well known to the person skilled in the art and hence the explanation is thereof omitted.

Although the present embodiments have been described with reference to specific example embodiments, it will be evident that various modifications and changes may be made to these embodiments without departing from the broader spirit and scope of the various embodiments. Furthermore, the various devices, modules, analyzers, generators, and the like described herein may be enabled and operated using hardware circuitry, for example, complementary metal oxide semiconductor based logic circuitry, firmware, software and/or any combination of hardware, firmware, and/or software embodied in a machine readable medium. For example, the various electrical structure and methods may be embodied using transistors, logic gates, and electrical circuits, such as application specific integrated circuit.

1. A method of a base station in a telecommunication network for communicating low duty cycle (LDC) pattern information to one or more mobile stations, the method comprising:
determining validity of one or more LDC patterns used during a LDC mode by at least one femtocell associated with one or more mobile stations; and
communicating LDC pattern information associated with the one or more valid LDC patterns to the one or more mobile stations.

2. A method of a mobile station for obtaining low duty cycle (LDC) pattern information from a base station of a telecommunication network, the method comprising:
receiving a message indicating a change in LDC pattern information associated with one or more valid LDC patterns from the base station, wherein the one or more valid LDC patterns are used during a LDC mode by at least one femtocell associated with the mobile station;
performing a network entry procedure with the base station upon receiving the message; and
obtaining the LDC pattern information associated with the one or more valid LDC patterns from the base station during the network entry procedure.

3. A mobile station for obtaining low duty cycle (LDC) pattern information from a base station of a telecommunication network, the mobile station comprising:
a processor; and
memory coupled to the processor and configured to temporarily store instructions capable of:
receiving a message indicating a change in LDC pattern information associated with one or more valid LDC patterns from the base station, wherein the one or more valid LDC patterns are used during a LDC mode by at least one femtocell associated with the mobile station;
performing a network entry procedure with the base station upon receiving the message indicating the change in the LDC pattern information; and
obtaining the LDC pattern information associated with the one or more valid LDC patterns from the base station during the network entry procedure.

4. The method of claim 1, wherein the LDC pattern information associated with the one or more valid LDC patterns comprises at least one of a set of LDC parameters, a change count, and time associated with applicability of the set of LDC parameters.

5. The method of claim 1, wherein the validity of the one or more LDC patterns is determined upon receiving the one or more LDC patterns from an entity in the telecommunication network.

6. The method of claim 1, wherein the validity of the one or more LDC patterns is determined upon receiving a request for LDC pattern information associated with one or more valid LDC patterns from the one or more mobile stations.

7. The method of claim 1, wherein communicating the LDC pattern information associated with the one or more valid LDC patterns to the one or more mobile stations comprises:
broadcasting or multicasting/unicasting the LDC pattern information associated with the one or more valid LDC patterns to the one or more mobile stations in real time for a predetermined time interval such that the one or more mobile stations updates the broadcasted or multicasted/unicasted LDC pattern information.

8. The method of claim 7, wherein communicating the LDC pattern information associated with the one or more valid LDC patterns to the one or more mobile stations, further comprises:
generating a message indicating a change in LDC pattern information associated with the one or more valid LDC patterns;
sending the message to the one or more mobile stations associated with the at least one femtocell;
receiving a network entry procedure request from the one or more mobile stations in response to the message.

9. (canceled)

10. The method of claim 7, wherein the predetermined time interval comprises a time interval associated with at least one longest active paging cycle in the telecommunication network.

11. The method of claim 7, wherein, the message is one of a broadcast message, a multicast message, and a unicast message, and wherein the one of broadcast message, multicast message, and unicast message is selected from the group consisting of a paging message, a new advertisement message, and a handover command message.

12. The method of claim 1, wherein the base station is selected from the group consisting of a femto base station, a pico base station, and a macro base station.

13.-14. (canceled)

15. A base station for communicating low duty cycle (LDC) pattern information to one or more mobile stations, the base station comprising:
a processor; and
a memory coupled to the processor and configured to temporarily store instructions capable of:
determining validity of one or more LDC patterns used during a LDC mode by at least one femtocell associated with the one or more mobile stations; and
communicating LDC pattern information associated with the one or more valid LDC patterns to the one or more mobile stations.

16. The base station of claim 15, wherein the LDC pattern information associated with the one or more valid LDC patterns comprises at least one of a set of LDC parameters, a change count, and time associated with applicability of the set of LDC parameters.

17. The base station of claim 16, wherein the set of LDC parameters comprises an available interval, an unavailable interval, and a start offset.

18. The base station of claim 15, wherein the instructions to determine validity of one or more LDC patterns comprises:
receiving the one or more LDC patterns from an entity in a telecommunication network; and
determining validity of the received one or more LDC patterns used during the LDC mode by the at least one femtocell associated with the one or more mobile stations.

19. The base station of claim 15, wherein the instructions to determine validity of one or more LDC patterns comprises:
receiving a request for LDC pattern information associated with the one or more valid LDC patterns from the one or more mobile stations; and
determining validity of one or more LDC patterns used during the LDC mode by the at least one femtocell associated with the one or more mobile stations based on the received request.

20. The base station of claim 15, wherein the instructions to communicate the LDC pattern information associated with one or more valid LDC patterns to the one or more mobile stations comprises:
broadcasting or multicasting/unicasting the LDC pattern information associated with the one or more valid LDC patterns to the one or more mobile stations in real time for a predetermined time interval during the network entry procedure with the one or more mobile stations.

21. The base station of claim 20, wherein the instructions to communicate the LDC pattern information associated with one or more valid LDC patterns to the one or more mobile stations further comprises:
generating a message indicating a change in LDC pattern information associated with the one or more valid LDC patterns;
sending the message to the one or more mobile stations associated with the at least one femtocell; and
receiving a network entry procedure request from the one or more mobile stations in response to the message.

22. The base station of claim 21, wherein the predetermined time interval comprises a time interval associated with at least one longest active paging cycle in the telecommunication network.

23. The base station of claim 21, wherein the message is one of a broadcast message, a multicast message, and a unicast message, and wherein the one of broadcast message, multicast message, and unicast message is selected from the group consisting of a paging message, a new message, and a handover command message.

24. The base station of claim 15, wherein the base station is selected from the group consisting of a femto base station, a pico base station, and a macro base station.

25. The method of claim 4, wherein the set of LDC parameters comprises an available interval, an unavailable interval, and a start offset.

26. The method of claim 2, wherein the LDC pattern information associated with the one or more valid LDC patterns comprises at least one of a set of LDC parameters, a change count, and time associated with applicability of the set of LDC parameters.

27. The method of claim 26, wherein the set of LDC parameters comprises an available interval, an unavailable interval, and a start offset.

28. The method of claim 2, wherein the message is one of a broadcast message, a multicast message, and a unicast message, and wherein the one of broadcast message, multicast message, and unicast message is selected from the group consisting of a paging message, a new advertisement message, and a handover command message.

29. The method of claim 2, wherein the base station is selected from the group consisting of a femto base station, a pico base station, and a macro base station.

30. The mobile station of claim 3, wherein the LDC pattern information associated with the one or more valid LDC patterns comprises at least one of a set of LDC parameters, a change count, and time associated with applicability of the set of LDC parameters.

31. The mobile station of claim 30, wherein the set of LDC parameters comprises an available interval, an unavailable interval, and a start offset.

32. The mobile station of claim 3, wherein the message is one of a broadcast message, a multicast message, and a unicast message, and wherein the one of broadcast message, multicast message, and unicast message is selected from the group consisting of a paging message, a new message, and a handover command message.

33. The mobile station of claim 3, wherein the base station is selected from the group consisting of a femto base station, a pico base station, and a macro base station.
